(19) United States
(12) Patent Application Publication
(10) Pub. No.: US 2009/0206584 A1
(43) Pub. Date: Aug. 20, 2009

(54) Side Impact Protection Device With A Pelvic Airbag Module

(75) Inventors: Georg Bauer, Weinsberg (DE); Thomas Schoettker, Grafenau (DE); Nico Siebert, Althengstett (DE)

Correspondence Address: CROWELL & MORING LLP;INTELLECTUAL PROPERTY GROUP, P.O. BOX 14300, WASHINGTON, DC, 20044-4300, US

(73) Assignee: Daimier AG, Stuttgart (DE)

(21) Appl. No.: 12/089,923

(22) PCT Filed: Sep. 28, 2006
(86) PCT No.: PCT/EP2006/009431

§ 371 Date: Jul. 9, 2008

(30) Foreign Application Priority Data
Oct. 12, 2005 (DE) 10 2005 048 842.0

(51) Int. Cl. B60R 21/16

(52) U.S. Cl. 280/730.2

(57) ABSTRACT

A side impact protection device with a pelvic airbag module having a pelvic airbag which, in the inoperative state, is in a side part of a vehicle seat and, in the event of an impact of the vehicle, can be inflated and can be deployed through an outlet opening in the side part of the vehicle seat. In order to provide a side impact protection device constructed in a simple manner and produced cost-effectively, the outlet opening for the pelvic airbag in the side part of the vehicle seat is directed upward and forward with respect to the direction of travel of the vehicle.

### BACKGROUND AND SUMMARY OF THE INVENTION

This application is a national stage of PCT International Application No. PCT/EP2006/009431, filed Sep. 28, 2006, which claims priority under 35 U.S.C. § 119 to German Patent Application No. 10 2005 048 842.0, filed Oct. 12, 2005, the disclosure of which is expressly incorporated by reference herein.

The invention relates to a side impact protection device with a pelvic airbag module. The pelvic airbag module comprises a pelvic airbag which, in the inoperative state, is located in a side part of a vehicle seat. In the event of an impact of the vehicle, the pelvic airbag can be inflated and deployed through an outlet opening provided in the side part of the vehicle seat.

German laid-open specification DE 199 04 739 A1 discloses a safety device for a motor vehicle with a side airbag which is a combined pelvic and thorax airbag. German Utility Model DE 297 08 494 U1 discloses a side impact protection device for vehicle occupants with an inflatable protective cushion which, in the inoperative state, is stowed in a vehicle door and emerges from the latter when activated.

It is the object of the invention to provide a side impact protection device which is constructed in a simple manner and can be produced cost-effectively.

The object is achieved in a side impact protection device with a pelvic airbag module which comprises a pelvic airbag and an outlet opening. The pelvic airbag is located in a side part of a vehicle seat. In the event of an impact of the vehicle, the pelvic airbag can be inflated and deployed through the outlet opening. The outlet opening for the pelvic airbag is directed upward and forward, with respect to the direction of travel of the vehicle. This simplifies the guidance of the airbag as it is deployed.

A preferred embodiment of the side impact protection device has the outlet opening for the pelvic airbag in the side part of the vehicle seat arranged in the vicinity of an axis of rotation of the vehicle seat backrest. This arrangement has proven particularly advantageous within the scope of the present invention.

A further preferred embodiment of the side impact protection device has the outlet opening for the pelvic airbag in the side part extending in a plane inclined away from the associated vehicle seat surface. This increases the cross section of the outlet opening.

An exemplary embodiment of the side impact protection device is in the inoperative state, the outlet opening for the pelvic airbag is closed by a covering element. In the event of an impact of the vehicle, the covering element can be pivoted about a pivot axis arranged on that side of the side part which faces away from the vehicle seat surface. The pivot axis can be defined, for example, by means of a film hinge between the side part and the covering element.

A further exemplary embodiment of the side impact protection device has the covering element connected to the side part by a rip line arranged on that side of the side part which faces the vehicle seat surface. The rip line is designed in such a manner that it rips in the event of an impact of the vehicle.

Another embodiment of the side impact protection device is when the side part of the vehicle seat has a limb that at least partially accommodates the pelvic airbag module. The limb extends upward obliquely to the rear, with respect to the direction of travel of the vehicle. This location has proven particularly advantageous within the scope of the present invention for accommodating the pelvic airbag module.

A further preferred embodiment of the side impact protection device has the outlet opening for the pelvic airbag arranged in a wall of the limb of the side part. The wall is directed upward, to the front, with respect to the direction of travel of the vehicle. This arrangement has proven particularly advantageous within the scope of the present invention.

The invention also relates to a vehicle seat with a side impact protection device described previously and to a motor vehicle with a vehicle seat of this type.

Further advantages, features and details of the invention emerge from the description below in which an exemplary embodiment is described in detail with reference to the drawing. In this case, the features mentioned in the claims and in the description may each individually be essential to the invention by themselves or in any desired combination.

Other objects, advantages and novel features of the present invention will become apparent from the following detailed description of the invention when considered in conjunction with the accompanying diagrams.

### BRIEF DESCRIPTION OF THE DRAWINGS

FIG. 1 shows a perspective illustration of a vehicle seat with a side impact protection device according to the invention.

FIG. 2 shows the view of a section along the line II-II in FIG. 1.

### DETAILED DESCRIPTION OF THE DRAWINGS

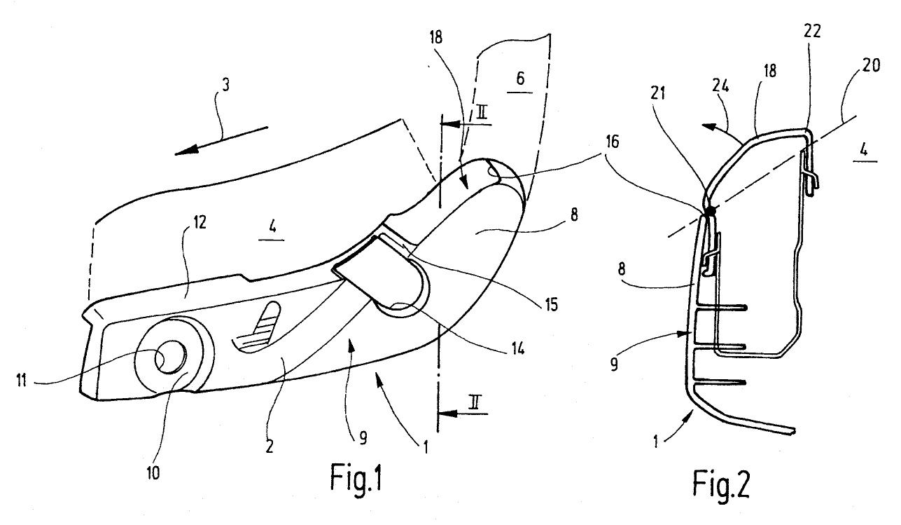

FIG. 1 illustrates a perspective view of a side part 1 of a vehicle seat of a motor vehicle. The side part 1 comprises a base 2 which is essentially in the form of an elongated cuboid and extends in the direction of travel 3 of the motor vehicle. The base 2 of the side part 1 is arranged to the side of a vehicle seat surface 4, which is merely indicated by dashed lines in FIG. 1. The seat backrest 6, which is likewise merely indicated by dashed lines, extends upward in a known manner from the vehicle seat surface 4. The seat backrest 6 can be pivoted about an axis of rotation relative to the vehicle seat surface. The axis of rotation is also referred to as the pivot axis.

A limb 8 of the side part 1 extends upward from the base 2, obliquely to the rear, with respect to the direction of travel 3. On the side facing the vehicle seat surface 4, the limb 8 and the base 2 are bounded by a common side wall 9. At its front end, the side wall 9 has a circular depression 10 with a passage hole 11 for a seat adjustment device (not illustrated). The base 2 of the side part 1 is upwardly closed by means of an upper end wall 12. A cut-out 14 for a seat belt fitting part (not illustrated) is provided in the upper end wall 12. The limb 8 of the side part 1 is upwardly closed by means of an upper end wall 15. An outlet opening 16 is provided in the upper end wall 15 for a pelvic airbag of a pelvic airbag module. The outlet opening is accommodated in the interior of the limb 8 of the side part 1. The outlet opening 16 is closed by means of a covering element 18. The pelvic airbag is also referred to as a pelvis airbag.

FIG. 2 illustrates the view of a section along the line II-II in FIG. 1. In the sectional view, the outlet opening 16 in the limb 8 of the side part 1 extends in a plane 20 which is inclined obliquely outward from the vehicle seat surface 4. When the pelvic airbag module is activated, the covering element can be pivoted about a pivot axis 21 which runs perpendicularly to the plane of the drawing. The pivot axis 21 is formed, for example, by a film hinge between the side wall 9 of the limb 8 and the covering element 18. A rip line 22 on that side of the limb 8 which faces the seat runs parallel to the pivot axis 21. If the airbag module in the interior of the limb 8 is activated, then the covering element rips along the rip line 22 and pivots about the pivot axis 21, as indicated by an arrow 24. This opens up the outlet opening 16 such that the airbag can emerge and can deploy in the region of the pelvis of a person sitting on the vehicle seat.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-9. (canceled)

10. A side impact protection device with a pelvic airbag module comprising:
an outlet opening in a side part of a vehicle seat directed upward and forward with respect to the direction of travel of the vehicle; and
a pelvic airbag in the side part of the vehicle seat, wherein in the event of an impact of the vehicle the airbag can be inflated and deployed through the outlet opening.

11. The side impact protection device as claimed in claim 10, wherein the outlet opening for the pelvic airbag is located near to an axis of rotation of a vehicle seat backrest.

12. The side impact protection device as claimed in claim 10, wherein the outlet opening for the pelvic airbag extends away from a surface of the vehicle seat.

13. The side impact protection device as claimed in claim 10, wherein the outlet opening for the pelvic airbag is closed by a covering element which pivots away from the vehicle seat surface on an axis on the side part of the vehicle seat.

14. The side impact protection device as claimed in claim 13, wherein the covering element is connected by a rip line to the side part of the vehicle seat.

15. The side impact protection device as claimed in claim 10, wherein the pelvic airbag is at least partially located in a limb on the side part of the vehicle seat, and the limb is extending upward obliquely to the rear with respect to the direction of travel of the vehicle.

16. The side impact protection device as claimed in claim 15, wherein the outlet opening for the pelvic airbag is arranged in a wall of the limb and wherein the wall is directed upward to the front with respect to the direction of travel of the vehicle.

17. A vehicle seat with a side impact protection device as claimed in claim 16.

18. A motor vehicle with a vehicle seat as claimed in claim 17.
